(19) United States
(12) Patent Application Publication
(10) Pub. No.: US 2014/0136368 A1
(43) Pub. Date: May 15, 2014

(54) AVATAR HAVING ARTIFICIAL INTELLIGENCE FOR FACILITATING THE CREATION OF PERSONAL DECISION CONTRACTS

(71) Applicant: Robert Brazell, Salt Lake City, UT (US)

(72) Inventor: Robert Brazell, Salt Lake City, UT (US)

(21) Appl. No.: 13/926,965

(22) Filed: Jun. 25, 2013

Related U.S. Application Data
(60) Provisional application No. 61/726,462, filed on Nov. 14, 2012.

(51) Int. Cl. G06Q 30/06

(52) U.S. Cl. CPC G06Q 30/0613
USPC 705/26.41; 705/3

(57) ABSTRACT

The present invention extends to methods, systems, and computer program products for implementing an avatar marketplace within which an avatar can enter into personal decision contracts with other avatars to receive goods or services on behalf of the individuals or entities represented by the avatars. An avatar acts as a digital representation of a user by continually searching for information and analyzing the information to provide recommendations of decisions the user may make. The personal decision contracts entered into by the avatar can be commitments to follow a decision recommended by the avatar at a future time. Such contracts can be entered into with other entities or avatars. The avatar can maintain a score that represents the level of trust that the user has in the avatar which is based on how often the user complies with his commitments in a personal decision contract.

### CROSS-REFERENCE TO RELATED APPLICATIONS

This application claims the benefit of U.S. Provisional Patent Application No. 61/726,462 which was filed on Nov. 14, 2012.

### BACKGROUND

An average person may spend many hours a day making decisions. For example, a person makes many decisions regarding what to do with the person's time, what to spend money or resources on, who to interact with, etc. Such decisions are often made using only minimal information without considering the overall effect the decisions will have on the person's short or long-term well-being.

One reason why such decisions are made on limited information is that an adequate system of measuring the utility generated by making decisions does not exist. For example, although a price can be placed on many items, activities, services, etc. that a person may desire, the price does not quantify the benefit or detriment the person will incur when making such a purchase.

### BRIEF SUMMARY

The present invention extends to methods, systems, and computer program products for implementing an avatar marketplace within which an avatar can enter into personal decision contracts with other avatars to receive goods or services on behalf of the individuals or entities represented by the avatars. An avatar acts as a digital representation of a user by continually searching for information and analyzing the information to provide recommendations of decisions the user may make.

The avatar can be configured to enter into a personal decision contract on behalf of the individual to receive goods or services that the avatar has identified would be beneficial to the individual. In some embodiments, the utility of a decision can be quantified.

By generating quantified measurements of the utility of a decision, the avatar can provide the user with a simplified way to make educated decisions that will maximize the user's happiness. These decisions can relate to how the user spends his money or other resources, how the user spends his time, or any other type of decision that may have an effect on the user's well-being. For example, the decisions may relate to health care procedures or health related activities to improve the user's health, education or training to improve the user's economic worth, material possessions, etc.

The personal decision contracts entered into by the avatar can be commitments to follow a decision recommended by the avatar at a future time. Such contracts can be entered into with other entities or avatars. The avatar can maintain a score that represents the level of trust that the user has in the avatar which is based on how often the user complies with his commitments in a personal decision contract.

A person's avatar can represent the person in a marketplace for entering into personal decision contracts. The marketplace acts as an exchange for transacting with other people either directly or via their avatars. A person can enter into commitments to follow his avatar's recommendation or decision as it relates to a personal decision the person would otherwise make. In this way, the person is able to rely on his avatar to become sufficiently educated to make the best decision for the person. In this manner, the person can be freed from taking the time and effort to make appropriate personal decisions for himself. The personal decisions can relate to health, diet, finances, recreation, or any other subject.

In one embodiment, the present invention is implemented as a method for accessing a marketplace of avatars to enter into a personal decision contract on behalf of the represented individual. A marketplace for allowing avatars to enter into personal decision contracts is provided. The marketplace comprises an online repository of goods and services offered by individuals or entities. These individuals and entities are each represented by an avatar. Each avatar comprises a collection of information about various subject matters obtained by the avatar as well as information specific to the represented individual or entity.

A first avatar processes information collected about a first subject matter and information specific to an individual represented by the first avatar. Using the information specific to the represented individual, the first avatar identifies a decision with regards to the first subject matter that is determined to provide the most benefit to the represented individual. The decision comprises a decision to obtain one or more goods or services.

The first avatar presents the decision to the represented individual and receives acceptance of the decision from the represented individual. The first avatar then searches the marketplace to identify another avatar that offers the one or more goods or services. After identifying another avatar, the first avatar enters into a personal decision contract with the other avatar on behalf of the represented individual to purchase the one or more goods or services.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1-2 illustrate an exemplary computer environment in which the present invention can be implemented;

FIGS. 3 and 4A-4E illustrate an exemplary display that can be provided to enable a user to interact with an avatar;

FIG. 5 illustrates a logical representation of an avatar marketplace; and

FIG. 6 illustrates a flowchart of an exemplary method for providing an avatar marketplace for entering into personal decision contracts.

### DETAILED DESCRIPTION

The present invention extends to methods, systems, and computer program products for implementing an avatar marketplace within which an avatar can enter into personal decision contracts with other avatars to receive goods or services on behalf of the individuals or entities represented by the avatars. An avatar acts as a digital representation of a user by continually searching for information and analyzing the information to provide recommendations of decisions the user may make.

The avatar can be configured to enter into a personal decision contract on behalf of the individual to receive goods or services that the avatar has identified would be beneficial to the individual. In some embodiments, the utility of a decision can be quantified.

By generating quantified measurements of the utility of a decision, the avatar can provide the user with a simplified way to make educated decisions that will maximize the user's happiness. These decisions can relate to how the user spends his money or other resources, how the user spends his time, or any other type of decision that may have an effect on the user's well-being. For example, the decisions may relate to health care procedures or health related activities to improve the user's health, education or training to improve the user's economic worth, material possessions, etc.

The personal decision contracts entered into by the avatar can be commitments to follow a decision recommended by the avatar at a future time. Such contracts can be entered into with other entities or avatars. The avatar can maintain a score that represents the level of trust that the user has in the avatar which is based on how often the user complies with his commitments in a personal decision contract.

A person's avatar can represent the person in a marketplace for entering into personal decision contracts. The marketplace acts as an exchange for transacting with other people either directly or via their avatars. A person can enter into commitments to follow his avatar's recommendation or decision as it relates to a personal decision the person would otherwise make. In this way, the person is able to rely on his avatar to become sufficiently educated to make the best decision for the person. In this manner, the person can be freed from taking the time and effort to make appropriate personal decisions for himself. The personal decisions can relate to health, diet, finances, recreation, or any other subject.

In one embodiment, the present invention is implemented as a method for accessing a marketplace of avatars to enter into a personal decision contract on behalf of the represented individual. A marketplace for allowing avatars to enter into personal decision contracts is provided. The marketplace comprises an online repository of goods and services offered by individuals or entities. These individuals and entities are each represented by an avatar. Each avatar comprises a collection of information about various subject matters obtained by the avatar as well as information specific to the represented individual or entity.

A first avatar processes information collected about a first subject matter and information specific to an individual represented by the first avatar. Using the information specific to the represented individual, the first avatar identifies a decision with regards to the first subject matter that is determined to provide the most benefit to the represented individual. The decision comprises a decision to obtain one or more goods or services.

The first avatar presents the decision to the represented individual and receives acceptance of the decision from the represented individual. The first avatar then searches the marketplace to identify another avatar that offers the one or more goods or services. After identifying another avatar, the first avatar enters into a personal decision contract with the other avatar on behalf of the represented individual to purchase the one or more goods or services.

Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Example Computer Environment

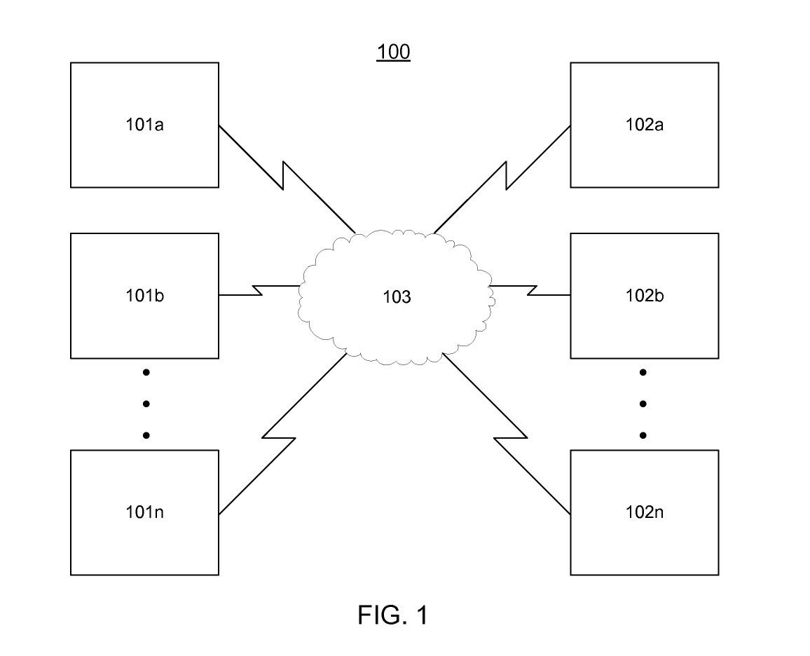

FIG. 1 illustrates an example computer environment 100 in which the present invention can be implemented. Computer environment 100 includes server computing systems 101a-101n and client computing devices 102a-102n which are connected via a network 103. Computer environment 100 in a typical environment can represent the internet.

Server computing systems 101a-101n represent any type of computer system connected to network 103 that stores content accessible from one or more of client computer devices 102a-102n. For example, each of server computing systems 101a-101n can comprise any number of computer systems or resources such as a single server or a cloud of interconnected computer resources. In other words, the present invention should not be limited to any particular computer or network configuration or infrastructure.

Client computing devices 102a-102n can represent any type of computing device capable of communicating with any of server computing systems 101a-101n over network 103. Examples of client computing devices 102a-102n include desktop computers, laptop computers, tablets, mobile phones, other smart electronic devices, etc. Although in most implementations, network 103 will be the internet, any type of network or direct connection between a client computer device 102 and a server computing system 101 could be used in addition to or in place of the internet.

Avatar Functionality

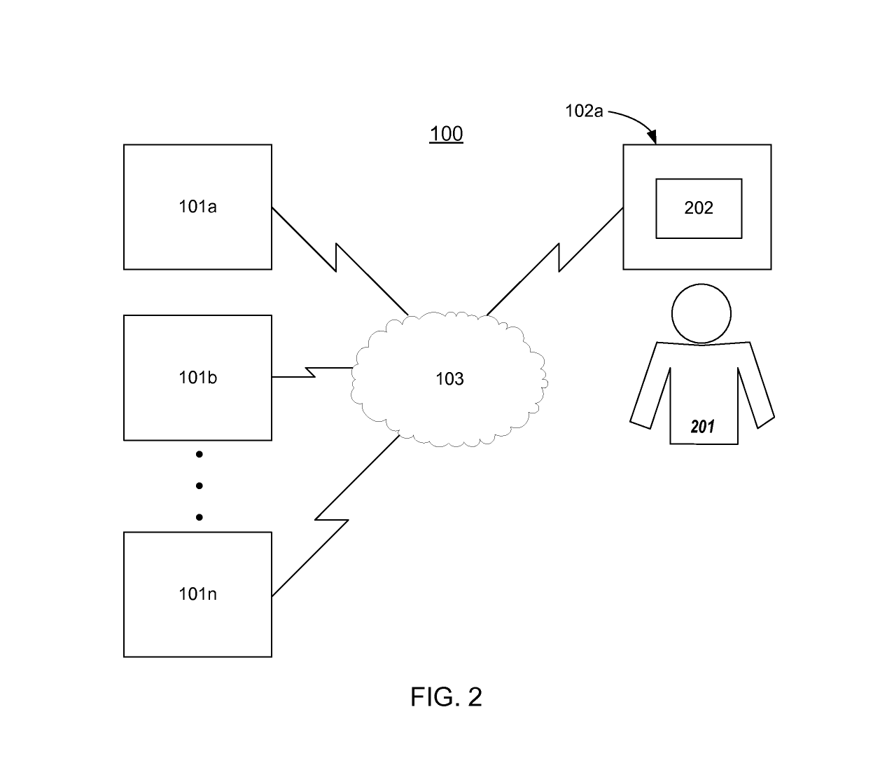

FIG. 2 represents computer environment 100 when a user 201 is using client computing device 102a to communicate with an avatar 202 in accordance with one or more embodiments of the invention. Avatar 202 comprises computer executable logic for obtaining information from user 201, searching for and identifying relevant information available via network 103, and using the information obtained from the user and via network 103 to present recommendations to user 201 and to enter into personal decision contracts on behalf of user 201. In some embodiments, avatar 202 can be displayed on a computer device as a person, character, animal, or other figure which interacts with user 201.

Although avatar 202 is shown as being located on client computing device 102a, it is to be understood that not all of the logic for implementing avatar 202 needs to be located on client computing device 102a. For example, avatar 202 can be based on one or more of server computer systems 101a-101n (e.g. server-based or cloud-based) with a user interface being provided locally on client computing device 102a to interface with user 201. Similarly, logic for implementing avatar 202 can be stored locally on client computing device 102a while the information learned by avatar 202 can be hosted partially or entirely on one or more of server computing systems 101a-101n. Of course, logic for implementing avatar 202 can be provided on multiple of client computing devices 102a-102n such as when user 201 uses a home computer, a work computer, and a mobile phone/tablet to interface with avatar 202. Accordingly, the specific manner in which avatar 202 is hosted is not essential to the invention.

Avatar 202 continually receives information via network 103 and from user 201 to enable avatar 202 to recommend decisions to user 201 that user 201 would likely make if he were making the decision himself. The information received from user 201 can include initial information received from user 201, as well as user 201's responses to previously presented recommendations.

Avatar 202 can be configured to continually learn about user 201. For example, avatar 202 can obtain information about medical, educational, financial, and preference characteristics of user 201. Medical characteristics can include user 201's genetic information, health history, current well-being, etc. Educational characteristics can include user 201's knowledge, training, or experience in various subjects or fields. Financial characteristics can include user 201's financial status such as available cash, investments, debt, property, etc. Preference characteristics can include any other information about user 201 such as activities the user enjoys, habits, previous interaction that user 201 has had with avatar 202, etc. In short, avatar 202 can learn any type of information about user 201 thereby allowing avatar 202 to most effectively function as a digital representative of user 201.

In addition to learning information about user 201, avatar 202 can also be configured to learn information from virtually any digitally available source. For example, avatar 202 can search over the internet for medical, educational, financial, health, or recreational information. Avatar 202 can be configured to analyze this information to determine both the value of the information to user 201 as well as the value of the information in identifying decisions to recommend to user 201. In other words, some information in and of itself may be sufficiently valuable to present to user 201 whereas other information may be used, analyzed, compiled, or otherwise processed by avatar 202 to assist avatar 202 in identifying which decisions will yield maximum utility when taken by user 201.

Because it learns information about user 201, avatar 202 is able to determine the personal benefit a decision will have on user 201. For example, the information obtained and analyzed by avatar 202 can have different levels of benefit or detriment for a particular individual. However, because avatar 202 is configured to quantify the utility of a decision based on what it knows about user 201, avatar 202 can identify a decision that user 201 would likely make if user 201 were to analyze the same information. In this way, avatar 202 can free user 201 from having to take the time to become sufficiently informed to make a decision that will maximize utility.

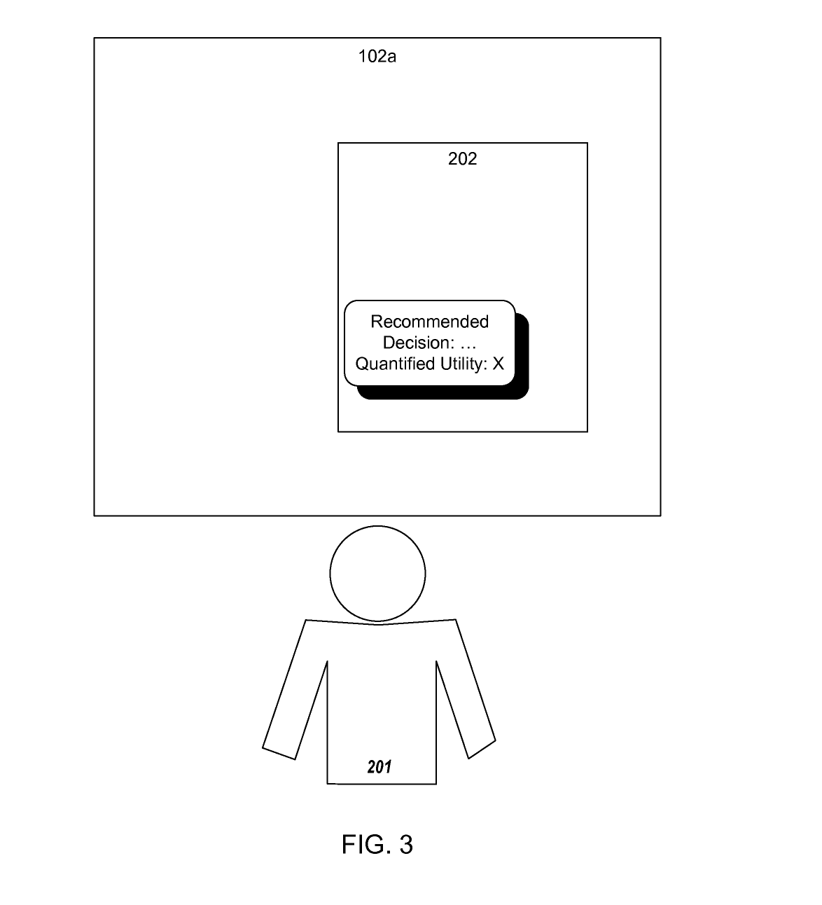

To assist user 201 in determining whether to accept a particular decision, avatar 202 can be configured to generate a quantified measurement of the utility of making the decision as shown in FIG. 3. The quantified measurement can take various forms based on the type of decision with which it is associated. For example, if the decision is a medical based decision, the quantified measurement can be based on the number of years that the decision will likely add to user 201's life expectancy. In such cases, the quantified measurement can also be based on the cost of making the decision such as the financial cost of undergoing a medical procedure or the cost of devoting time to make the decision.

In some embodiments, avatar 202 can also be configured to identify how user 201 is spending time or money on other decisions and can make recommendations to reallocate the time or money to make another decision that will provide more utility. For example, if avatar 202 determines that user 201 would greatly benefit by undergoing an expensive medical procedure, avatar 202 may determine the best way to reallocate user 201's funds to be able to pay for the medical procedure. In such cases, the quantified measurement can include a comparison of the benefit and cost.

In some cases, the decision may relate only to financial aspects of user 201's life. In such cases, the quantified measurement can include an indication of the cost of making a decision versus the expected increase in user 201's economic value from making the decision. For example, avatar 202 can determine based on discovered information that user 201 would likely increase his economic value by taking a class, reading a book, receiving training, etc. Avatar 202 can generate a quantified value that is based on the difference between the added economic value and the cost (in terms or money and/or time). In other words, added economic value can represent an increase in user 201's knowledge, experience, relevant information, or insight.

Personal Decision Marketplace

In some embodiments, avatar 202 can represent user 201 in a marketplace. Avatar 202 can include a score or other indicator representing user 201's various characteristics. For example, avatar 202 can portray user 201's financial, educational, medical, or recreational characteristics. These scores or indicators can be presented to other users or to other users' avatars thereby allowing others to enter into trades with user 201 via avatar 202.

In one example, these scores can be used to identify the trustworthiness of user 201 in keeping commitments entered into via the marketplace. For example, if avatar 202 presented a decision to user 201 recommending that user 201 enter into a commitment to purchase a certain product for a specified duration of time, avatar 202 can maintain a score that reflects whether user 201 upheld the commitment to purchase the product. One or more scores can similarly reflect user 201's history regarding commitments to exchange knowledge with other users, to receive certain services, or to enter into any other type of agreement. In this way, the marketplace, and more specifically avatar 202, enable user 201 to directly enter into agreements with other users or entities.

This marketplace can act as an exchange for entering into personal decision contracts. In other words, user 201 can agree to follow avatar 202's recommended decisions based on the assumption that avatar 202 identifies and recommends decisions that will most likely yield the greatest utility to user 201. As stated above, these decisions can be of any type including financial decisions (e.g. what car to buy, how to spend one's time), medical decisions (e.g. what preventative procedures to receive), educational decisions (e.g. what or where to learn), etc.

Once user 201 has agreed to follow avatar 202's decisions, user 201 can be freed from making these decisions himself. User 201's trustworthiness in keeping these commitments can act as an indication to other users (or other users' avatars) regarding the risk of entering into personal decision contracts with user 201.

For example, if avatar 202 recommends that user 201 purchase a particular car every four years for the next sixteen years, and another user (e.g. an auto dealer) agrees to sell the particular car at a specified price, each parties' commitment to this personal decision contract (and to other personal decision contracts) can be tracked and represented as a score of the user's commitment to contracts.

This score would be similar to a person's credit score. However, in contrast to a credit score, this score represents user 201's commitment to follow avatar 202's recommended decisions. The following example emphasizes this distinction. User 201 could agree to follow avatar 202's decision to purchase the best car for user 201 every four years. At the time that user 201 enters into this personal contract, user 201 does not know what car will be best, but still commits to allow avatar 202 to make the determination of which car is best for user 201 every four years. This personal decision contract could be entered into with a single car manufacturer (e.g. avatar 202 selects the best Ford model car), or can be entered into with multiple car manufacturers thereby incentivizing the multiple manufacturers to produce cars that will be best for user 201 (and therefore will be selected by avatar 202).

This example illustrates how avatar 202 can free user 201 from spending the required time to make the decision to purchase a car. Without avatar 202, user 201 has to do his own research every four years to determine which car to purchase. Further, user 201 will likely not perform sufficient research to be fully informed regarding which cars will be best for him. Avatar 202 performs this research for user 201 and uses the information that it knows about user 201 to make the best decision. As long as user 201 trusts avatar 202's decisions, user 201 is freed from the time and effort of making these and other types of personal decisions.

Companies or other entities can benefit by supplying necessary information for avatar 202 to make appropriate decisions. These companies can also benefit by receiving feedback from avatar 202 (and avatars of other users) that will assist the companies in producing goods or services that will provide the most benefit to the end users. In short, this marketplace can replace traditional means of advertising and selling goods or services by providing direct access to customers and their specific needs and desires as determined by their avatars. Further, by using avatars as representatives of users, the users' identities can remain anonymous during this process.

As another example, this marketplace can be used to create a personal decision contract to have a cancer screening procedure performed every year. Avatar 202, based on the information it has learned about user 201 (e.g. genetics, health history, family history, etc.) can determine that user 201 has a high risk of developing a certain cancer. Avatar 202 can also identify that a certain procedure is the best current procedure for early detection of the cancer and can enter into a personal decision contract on behalf of user 201 to have user 201 receive the procedure.

Further, avatar 202 can also determine that it is best for user 201 to have the best procedure available performed every year. Avatar 202 can research available information to determine criteria that can be used to select the best procedure in the future. Avatar 202 can then enter into a contract with an entity (e.g. a doctor, a clinic, a hospital, etc.) to provide the current best procedure each year for a specified duration of time. In this way, user 201 enters into a contract to have a procedure performed each year without knowing beforehand which procedure will be performed. User 201 relies on avatar 202 to make the best decision (which in this example is the decision of which criteria will be used to select a procedure in the future) given the available information.

Each year, user 201 fulfills his commitment to the personal decision contract by undergoing the cancer prevention procedure that is determined to be the best for user 201 at that time. User 201 is freed from having to continually research available options while still retaining the assurance that he is doing all he can to minimize his risk of developing cancer.

In the above example, if the personal decision contract is made with a particular clinic that performs cancer screening procedures, the clinic can use a score or other indicator provided by avatar 202 to determine whether to enter into the contract with user 201. For example, the contract can specify that user 201 will receive the procedure at a discounted rate each year in exchange for the commitment to have the best available procedure performed at the clinic each year. If the score maintained by avatar 202 indicates that user 201 generally keeps his commitment to follow avatar 202's decisions, the clinic will be better informed regarding user 201's likelihood of honoring the contract by having the procedure performed each year.

It is again noted that the score does not represent user 201's history of making payments as with a credit score, but is instead an indication of user 201's history of following avatar 202's recommendations when user 201 has agreed to do so. In the above example, the score represents user 201's likelihood of having a procedure, that is selected by avatar 202 (i.e. by the criteria specified by avatar 202), even when user 201 does not know the specific procedure that will be performed at the time of entering into the personal decision contract. In other words, the score can also be viewed as a representation of how much trust user 201 has in avatar 202.

In summary, avatar 202 constantly learns about user 201 and about any available information that is relevant to user 201's wellbeing. Avatar 202 uses this information to recommend decisions that are most likely to yield the greatest degree of utility or happiness to user 201. User 201's trust in avatar 202 can be quantified and used as a score in a marketplace where other entities or users can enter into personal decision contracts with user 201. These personal decision contracts are commitments to follow decisions made by avatar 202.

Cooking Recommendation Examples

As another example, user 201 can employ avatar 202 to make meal decisions on behalf of the user. In such cases, avatar 202 can receive meal related information from the user such as preferences of user 201, health or diet requirements or goals, etc. Avatar 202 can also learn from user by tracking user 201's responses to previously presented recommendations.

The information identified over network 103 can include recipes or ingredients for meals, related recipes or ingredients, substitutions for ingredients or meals, nutritional content or benefits of ingredients or meals, or any other type of information that is considered in determining what to eat for a meal. In some embodiments, avatar 202 can use user 201's response to recommendations to identify certain ingredients, qualities, or characteristics of meals or foods that user 201 is likely to prefer, and can formulate recommendations based on such information. For example, avatar 202 can identify common ingredients or qualities in meals that user 201 has identified that he has enjoyed and can identify (e.g. over network 103) other meals that share these ingredients or qualities.

Such recommendations can be based not only on user 201's preference for the taste of certain foods, but can also be based on one or more criteria related to user 201's health or diet goals or requirements. For example, avatar 202 can learn (either through direct input or via inference based on user 201's responses) that user 201 has a diet goal to eat a reduced amount of carbohydrates. Avatar 202 can use such information to identify foods or meals that user 201 would likely choose based on the flavor and content of the food.

Recommendations can also be made based on information about user 201's schedule. For example, if avatar 202 identifies a meal to recommend to user 201, but the meal requires a substantial amount of time to prepare, avatar 202 can recommend that the meal be prepared on a day in which user 201 has more free time before the meal. Similarly, if user 201 is scheduled to exercise after a meal, avatar 202 can identify a meal that is lighter or that provides additional carbohydrates.

Recommendations can also be made based on information about user 201's finances. For example, if avatar 202 identifies a meal to recommend to user 201, but the ingredients required to prepare the meal are more expensive, avatar 202 can recommend that the meal be prepared when user 201 has sufficient funds to cover the expense.

Avatar 202 can identify recommendations to make to user 201 for a specified duration of time. For example, avatar 202 may identify recommendations for a one week period. In addition to recommending the meals for the week, avatar 202 can also identify all ingredients that would be required to prepare each meal and present these ingredients to user 201. In this way, user 201 can easily identify which ingredients he will need to buy to prepare meals during the upcoming week.

Further, in some embodiments, avatar 202 can also be provided information regarding which ingredients user 201 already has. Avatar can use this information to identify only the ingredients that user 201 will need to purchase to prepare the meals. In this way, avatar 202 can provide a shopping list to user 201.

In some embodiments, avatar 202 can also be configured to automatically obtain necessary ingredients for recommended meals. For example, once avatar 202 has identified each ingredient user 201 will need that he does not already have, avatar 202 can order the necessary ingredients (e.g. via an online grocer).

By tracking which ingredients are required to prepare recommended meals as well as which ingredients and quantity of ingredients user 201 already has on hand, avatar 202 can proactively order necessary ingredients to ensure that user 201 always has what is needed to prepare recommended meals.

In some embodiments, avatar 202 can track the quantity of ingredients based on a response from user 201 regarding whether a meal or certain portion of a meal was prepared or modified. For example, if avatar 202 recommended a meal, at some later time, avatar 202 can prompt user 201 to confirm whether user 201 prepared and/or enjoyed the meal. If user 201 confirms that he prepared the meal, avatar 202 can automatically update the tracked quantities of any ingredients that would have been used to prepare the meal. For example, if the meal required one cup of flour, avatar 202 can decrement a cup from the tracked quantity of flour that user 201 has. If the quantity of flour falls below some threshold, avatar 202 can automatically order more.

In addition to providing a shopping list to user 201, avatar 202 can also use information obtained via network 103 to identify a location or multiple locations where the items on the shopping list can be obtained. Further, avatar 202 can also recommend one or more particular locations based on the price of the items at the particular locations. For example, avatar 202 can identify which retail locations provide the items on the list at the lowest total cost, or may identify, for each item, the retail location selling the item at the lowest price. Avatar 202 can take into account any coupons, offers, sales, or other discounts in identifying retail locations.

In some embodiments, avatar 202 can also identify a route within a retail location to optimize user 201's visit to the retail location. For example, avatar 202 can provide a map to guide user 201 through a retail location. Avatar 202 can also track items as the user obtains them within the retail location. For example, user 201 can scan a barcode on an item or otherwise identify an item to a client computing device 102 on which avatar 202 is executing. Based on this identification of items, avatar 202 can provide advertising, coupons, or other information related to the item, the retail location, or some other entity (e.g. by displaying an advertisement or coupon on the client computing device related to the item, another item, or the retail location).

In some embodiments, the avatar marketplace can be used to enter into personal decision contracts to obtain necessary ingredients from a particular retailer or supplier. For example, user 201 can employ avatar 202 to determine an appropriate retailer to obtain ingredients from, and can enter into an agreement to obtain future ingredients from the identified retailer in exchange for some benefit such as a discount on purchased ingredients.

Similarly, the avatar marketplace can be used to determine appropriate meal recommendations. For example, rather than selecting each meal recommendation by itself, avatar 202 can identify a source of recommendations that it determines will provide the best recommendations for user 201 and can enter into a personal decision contract to pass on recommendations from the source to user 201. In a particular example, avatar 202 can identify a diet plan that is most likely to benefit user 201 and can enter into a personal decision contract to receive meal recommendations from the diet plan and to present these meal recommendations to user 201. The personal decision contact can require that user 201 receive the meal recommendations, actually prepare the recommended meals, or any other level of commitment.

In some embodiments, avatar 202 can categorize meals into various categories. For example, categories can be created based on ingredients, meal type, style, weight, etc. For example, various criteria can be associated with each meal including when the meal may be eaten (breakfast, lunch, dinner, snack, etc.), the healthfulness of the meal (e.g. unhealthy, healthy, very healthy, completely healthy, etc.), the length of time required to prepare the meal and/or the length of time required to consume the meal (e.g. instant, 5-15 minutes, 15-30 minutes, 30-60 minutes, etc.).

These groupings of meals can be used by avatar 202 in determining which meal recommendations to provide to user 201. The logic for identifying a meal to recommend can be of various complexities which can be user configurable. For example, as described above, the selection of a meal recommendation can be based only on the user's indication of which meals he likes in which case each group can be formed using only criteria of which meals user 201 likes.

In contrast, the selection of a meal recommendation can be based on many criteria including some or all of the ingredients, price or availability of the ingredients, a user's schedule, goals, or dietary restrictions, whether the user has indicated an interest to try new foods, etc. Accordingly, avatar 202 can consider many different criteria from one meal to the next when making a recommendation. The information used to identify a meal to recommend can be constantly changing as avatar 202 learns more about meal options as well as about the user's preferences, status, schedule, or any other information about the user.

In some embodiments, avatar 202 can identify meal recommendations based on information unique to user 201. In other words, the decision regarding which meal to recommend can be based solely on information about meals and the information about the user. However, in some embodiments, avatar 202 can use information regarding other user's preferences towards meals in determining whether to recommend a meal to the user. For example, avatar 202 can access information obtained about other users (e.g. by other avatars employed by other users) to identify common trends among users such as by identifying a particular meal that is preferred by user's sharing common characteristics with user 201.

In one example, avatar 202 can determine that user 201 enjoys meals sharing various characteristics and that user 201 is scheduled to exercise after the meal. Accordingly, avatar 202 can access information obtained by other avatars regarding meals sharing the various characteristics that were enjoyed by other users prior to exercising. Any other combination of criteria (whether specific to user 201 or to other users) could also be used to determine a meal to recommend.

By making recommendations, avatar 202 can relieve user 201 of making many of the daily decisions that he would otherwise have to make. In this way, user 201 can be freed to invest his time focusing on other matters. However, the effectiveness of avatar 202 in relieving user 201 of making these decisions depends greatly on user 201's willingness to follow the recommendations presented by avatar 202. Because avatar 202 increases the accuracy of its recommendations over time by learning more about user 201, user 201 is encouraged to follow avatar 202's recommendations and report his feedback to avatar 202 regarding these recommendations. In time, avatar 202 can accumulate sufficient information about user 201 to become highly accurate in recommended a meal that will not only be enjoyed by user 201, but that will also promote user 201's other goals, interests, or activities. As this accuracy increases, user 201 can become more and more confident in avatar 202's recommendation thus allowing avatar 202 to make the meal related decisions in user 201's life.

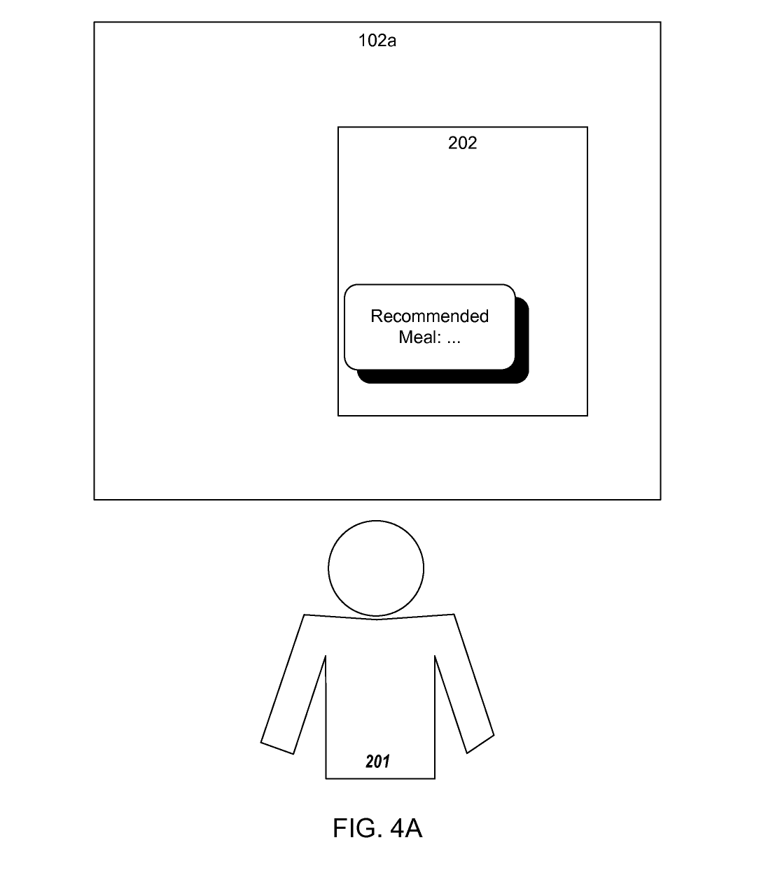

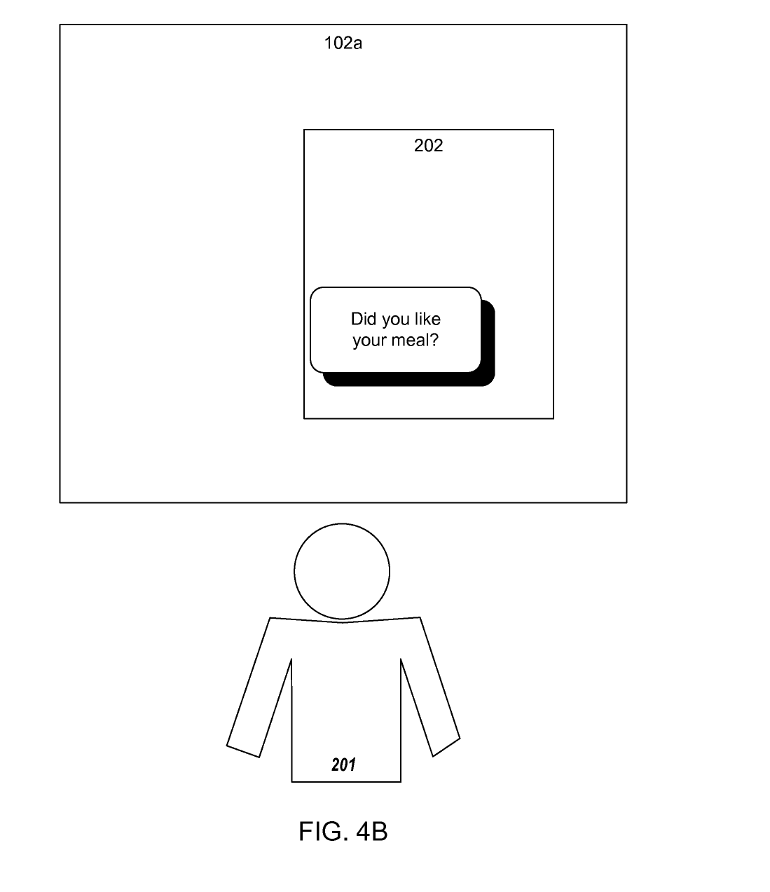

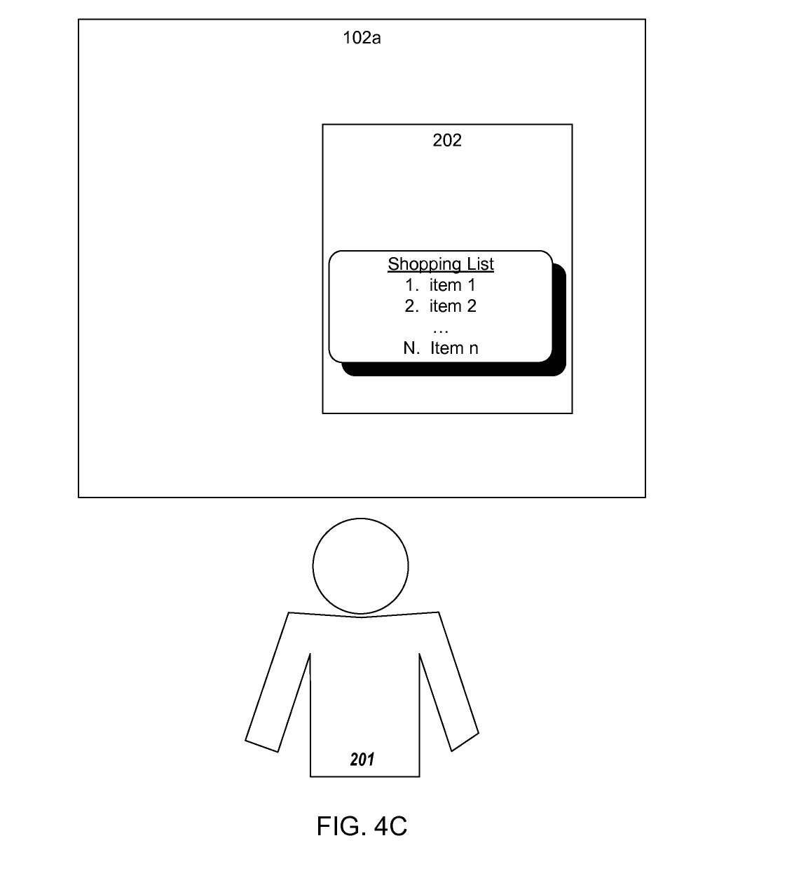

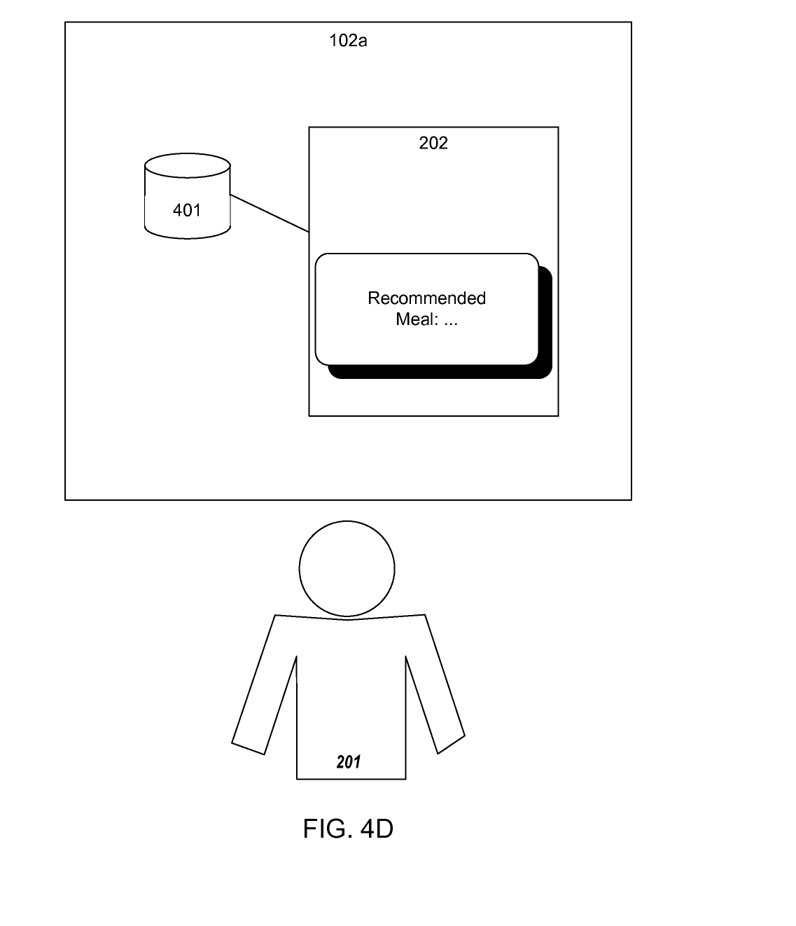

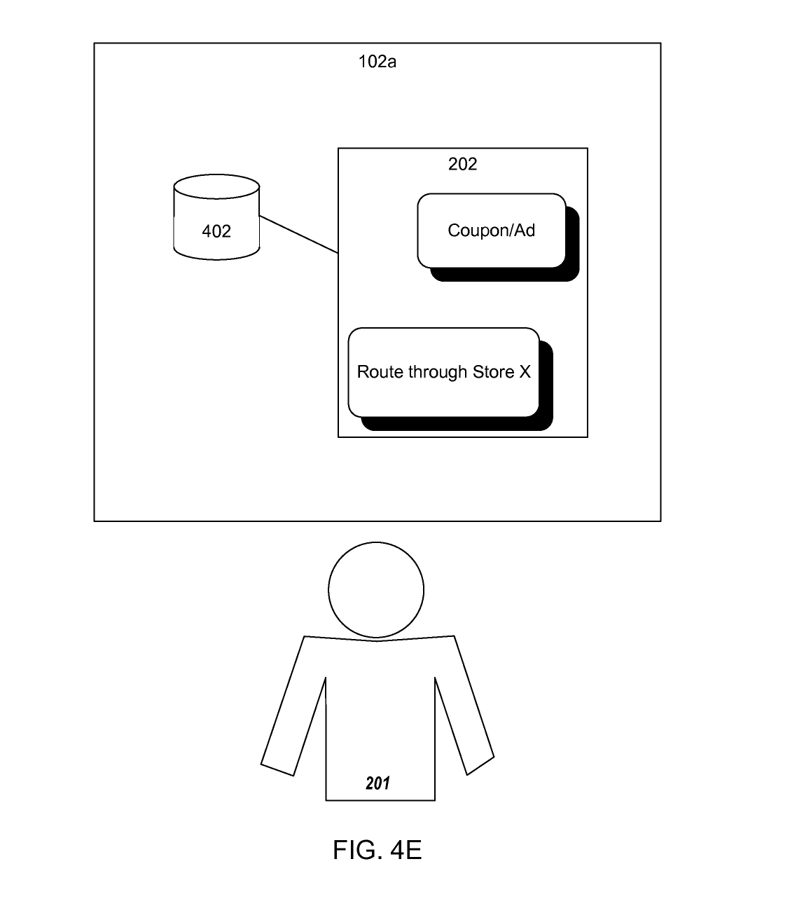

FIGS. 4A-4E illustrates how avatar 202 can interact with user 201. FIGS. 4A-4E display avatar 202 being executed on client computing device 102a. In FIG. 4A, avatar 202 has displayed a meal recommendation to user 201. The meal recommendation can be made based on any combination of information described above including information about user 201, information about meals and their ingredients, as well as information about other users. In some embodiments, the meal recommendation can be in the form of a recipe, shopping list, and/or shopping route. Also, meal recommendation, in some embodiments, can list the criteria used to select the meal recommendation, an option to request a different recommendation, and/or an option to provide feedback for the recommendation.

FIG. 4B illustrates an exemplary prompt that can be displayed by avatar 202 to request feedback from user 201 regarding a meal recommendation. In FIG. 4B, the prompt asks whether user 201 liked the meal. In some embodiments, a prompt can be displayed that asks whether user 201 prepared the meal (e.g. to update a quantity of ingredients that avatar 202 maintains), whether user 201 modified the meal in any way (e.g. by substituting ingredients, changing the quantity of any ingredients, etc.), whether the meal was appropriate for certain circumstances (e.g. before, during, or after certain activities, a status of user 201, etc.), etc. The feedback provided by user 201 can be used by avatar 202 in improving the quality of future meal recommendations.

FIG. 4C illustrates an exemplary shopping list that can be displayed to user 201. The shopping list can be displayed to user 201 in response to various input or circumstances (e.g. when user 201 has indicated a desire to prepare a recommended meal, when ingredients are needed for preparing a selected meal, when user 201 is shopping, etc.). The shopping list can display each item as well as a price, location, coupon, or other information for any item. The shopping list can also be customized based on an identified retail location. For example, if user 201 identifies a desire to shop at a particular retail location, the shopping list can be customized for the particular location. The shopping list can also include an option to request that avatar 202 order the items on the list for user 201 (e.g. via an online grocer or other retailer).

FIG. 4D illustrates that a database 401 can be accessed to determine recommendations. Database 401 can represent one or more databases that can be stored locally on client computing device 102a or on any other computing system accessible to avatar 202. Avatar 202 can update the content of database 401 as avatar 202 learns near information about user 201, meals, other users, etc.

FIG. 4E illustrates an exemplary display that avatar 202 can provide to inform user 201 of a route through a store as well as a coupon or advertisement that may be relevant to items on a shopping list or to the store. As shown, avatar 202 can access information in a database 402 to determine a route, coupon, ad, or other relevant information to display. Database 402 can represent a retail location's website or other storage location accessible by avatar 202, a third party mapping database, a coupon database, or any other source of information that avatar 202 can access to provide user 201 with assistance for shopping.

Medical Recommendation Examples

As another example, user 201 can employ avatar 202 to make medical decisions that user 201 would likely make if he were making the decision himself based on the same information. The information received from user 201 can include initial information received from user 201 (e.g. health information, financial information, preferences, etc.), subsequent information received from or about user 201 (e.g. health updates, financial updates, preference updates, etc.), and information derived from user 201's responses to previously presented recommendations.

Avatar 202 can search any available information (e.g. via the internet) to identify diseases that user 201 has a high propensity of developing. In other words, avatar 202 can be configured to search medical research or other findings that provide information regarding how it can be determined whether an individual is likely to develop a disease. In some embodiments, this information can include genetic markers, medical history of the user or the user's family, lifestyle, etc.

Avatar 202 can use information obtained from or about the user to determine whether the user is likely to develop a disease. For example, avatar 202 can receive the user's genome and compare it to the medical research to determine if the user has any genetic markers that indicate that the user has a high propensity to develop a particular disease. Additional medical information about the user can also be used in this determination such as the user's medical history, the user's family's medical history, the user's current health, diet, or activity level, etc. Accordingly, avatar 202 can use all available information regarding the user to determine which diseases the user has a high propensity to develop.

Once avatar 202 determines which diseases the user has a high propensity to develop, avatar 202 can create recommendations that the user can follow to decrease this propensity. For example, avatar 202 can be configured to search medical information to identify what types of changes an individual can make to address a particular propensity to develop a disease. Avatar 202 can be configured to use the information obtained about the user to select custom changes to recommend to the user.

For example, if it is determined that the user has a genetic marker indicating that the user has a high propensity to develop brain cancer, avatar 202 can search available medical information to determine many different ways that an individual having the same genetic marker can reduce the risk of developing brain cancer. Avatar 202 can then use the information obtained about the user to provide custom recommendations (e.g. selecting a particular way to address the risk that the user would likely choose).

Customizing recommendations in this manner makes avatar 202 much more helpful to the user. In particular, even though a user may be capable of researching the disease on his own, because of the large amount and complexity of the information, it may require an inordinate amount of time and effort for the user to identify a similar recommendation on his own. Because avatar 202 learns about the user as the user interacts with avatar 202, avatar 202 can contain sufficient artificial intelligence to make customized recommendations that will approximate the recommendation a user would make for himself if he were to fully research the disease.

Accordingly, avatar 202 can free the user from having to invest the time and effort to stay apprised of all the possible diseases he may be likely to develop as well as the lifestyle changes he should make to best address the likelihood of developing the diseases.

Avatar 202 can be configured to continually or periodically search for all relevant information. For example, if new research is published that has discovered that a particular genetic marker is an indicator of a high risk of a particular disease, avatar 202 can identify this new research and present new recommendations or modify existing recommendations accordingly. Similarly, if a new treatment or prevention mechanism is discovered for a disease that the user has a high propensity to develop, avatar 202 can inform the user of the new treatment or prevention mechanism including by making customized recommendations to implement the new treatment or prevention mechanism.

To customize a recommendation, avatar 202 can employ any information obtained about the user including specific medical characteristics (e.g. height, weight, injuries, or other conditions or diseases), preferences (e.g. whether the user prefers a particular type of exercise, diet, or schedule), the severity of the risk, etc. For example, if avatar 202 determines that the user's medical information indicates that the user is likely to develop diabetes, but that the user is unable to exercise (e.g. due to some injury or medical condition) or prefers not to exercise, avatar 202 can identify other lifestyle changes (e.g. diet changes) that the user is most likely to make, and recommend those changes. Similarly, if avatar 202 determines that the risk of diabetes was too great for diet alone, avatar 202 can identify and recommend specific types of exercises that, based on avatar 202's knowledge about the user (whether directly input by the user or inferred based on the user's feedback to previous recommendations), avatar 202 believes the user will most likely perform.

In some embodiments, in addition to making recommendations based on medical information only, avatar 202 can also use financial information to customize a recommendation. For example, avatar 202 may identify that a preventative treatment for a disease the user is likely to develop may cost a significant amount of money. Avatar 202 can be configured to learn about the user's finances so that avatar 202 is able to make recommendations that are financially suitable.

For example, if it is determined that the user is likely to develop a particular disease for which many different treatment or prevention options exist, avatar 202 can select a treatment or prevention option that is financially reasonable for the user. The recommendation can include an indication of how much it would cost the user to make the recommended change.

Determining what is financially reasonable can be based on many different factors. For example, the severity of the risk of developing the disease can be compared against the cost of receiving treatments for early detection to determine a most reasonable course of action.

A selected recommendation can also include a recommendation to change how the user is spending or is planning to spend his money. For example, if the user is likely to develop brain cancer, and an expensive treatment is available that is highly successful at preventing the cancer, avatar 202 can identify one or more alternative ways for the user to allocate his funds so that the user is able to afford the treatment (e.g. rather than purchasing a car with a $1,000/month payment, purchase a car with a $500/month payment to save the necessary $6,000 a year to pay for the treatment).

Accordingly, avatar 202 can serve as a digital representation of the user to continually search for potential diseases that the user could be likely to develop and to identify the changes that the user would most likely choose to make if the user himself had researched the disease.

In addition to identifying recommended decisions, avatar 202 can also be used to enter into personal decision contract related to user 201's health. For example, if avatar 202 recommends a particular decision to user 201, and user 201 accepts the decision, avatar 202 can search the marketplace to identify one or more other avatars that provide the goods or services recommended in the decision. Avatar 202 can identify an avatar that best provides the goods or services and enter into a personal decision contract to receive the goods or services from the entity represented by the identified avatar.

For example, if the recommended decision is to receive a preventative treatment, avatar 202 can identify many other avatars in the marketplace that offer the preventative treatment, and then select one of the avatars to provide the preventative treatment to user 201. The personal decision contract can specify that the user 201 receive the preventative treatment for a specified duration of time in exchange for some discount on the preventative treatment.

Marketplace Interaction Examples

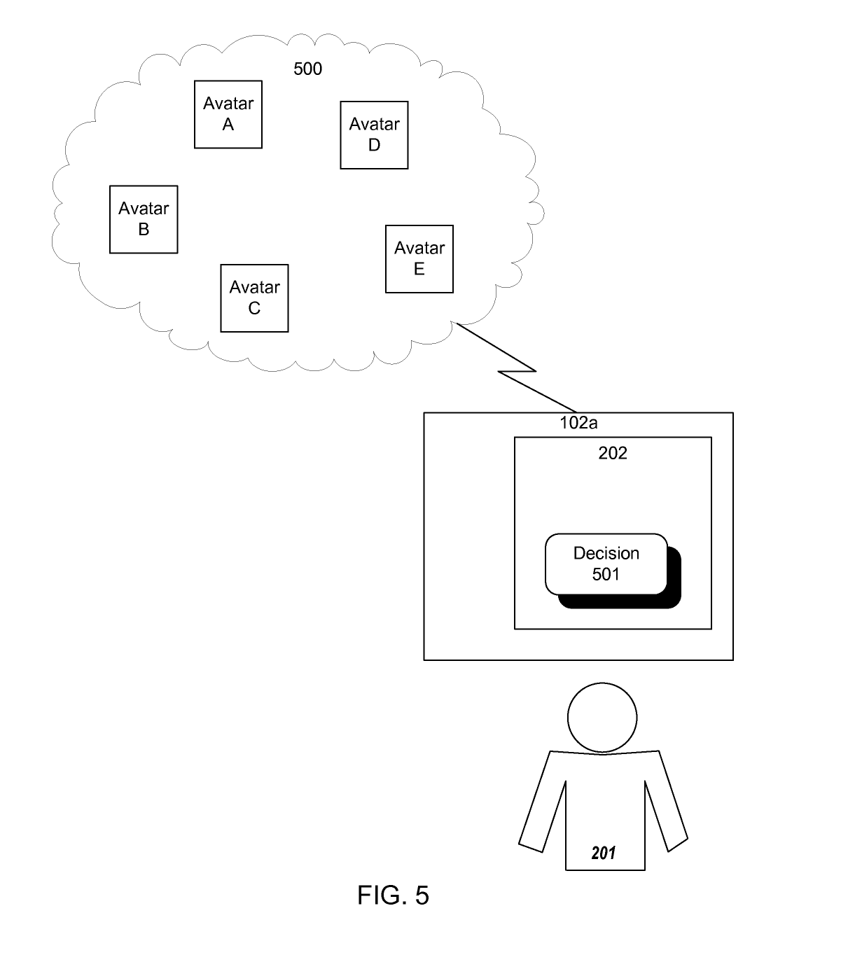

FIG. 5 illustrates a logical representation of a marketplace 500 in which avatars can identify and select goods and services offered by avatars of other individuals or entities. Marketplace 500 can be hosted in any network location that is accessible to client computing device 102a. FIG. 5 represents marketplace 500 as being hosted in the cloud, however, marketplace 500 could be hosted on any one or more specific server computing systems.

FIG. 5 illustrates that avatar 202 has recommended a decision 501 to user 201. In this example, decision 501 is a recommendation that user 201 receive a particular preventative treatment on a yearly basis. Avatar 202 could have identified decision 501 in any of the manners described above (e.g. by researching available information relevant to a particular risk that user 201 may have).

In some embodiments, decision 501 can be presented to user 201 to allow user 201 to accept or reject the decision. However, in other embodiments, avatar 202 can accept a decision without specific approval from user 201 (e.g. based on the decision exceeding some threshold for relevance or benefit to user 201, based on previous input from user 201, etc.).

FIG. 5 also shows that avatar 202 has identified a number of other avatars in the marketplace 500 (Avatars A-E) that represent entities that provide the particular preventative treatment. Avatar 202 can use various criteria to select one of the other avatars. Avatar 202 can enter into a personal decision contract with the selected other avatar for user 201 to receive the particular preventative treatment from the individual or entity represented by the other avatar on a yearly basis. The criteria used to select the other avatar can include price, location, rating, or any other combination of factors that indicate that the most benefit may be provided to user 201 by selected the particular avatar to provide the service. Avatar 202 can similarly enter into personal decision contracts on behalf of user 201 for many other types of personal decision.

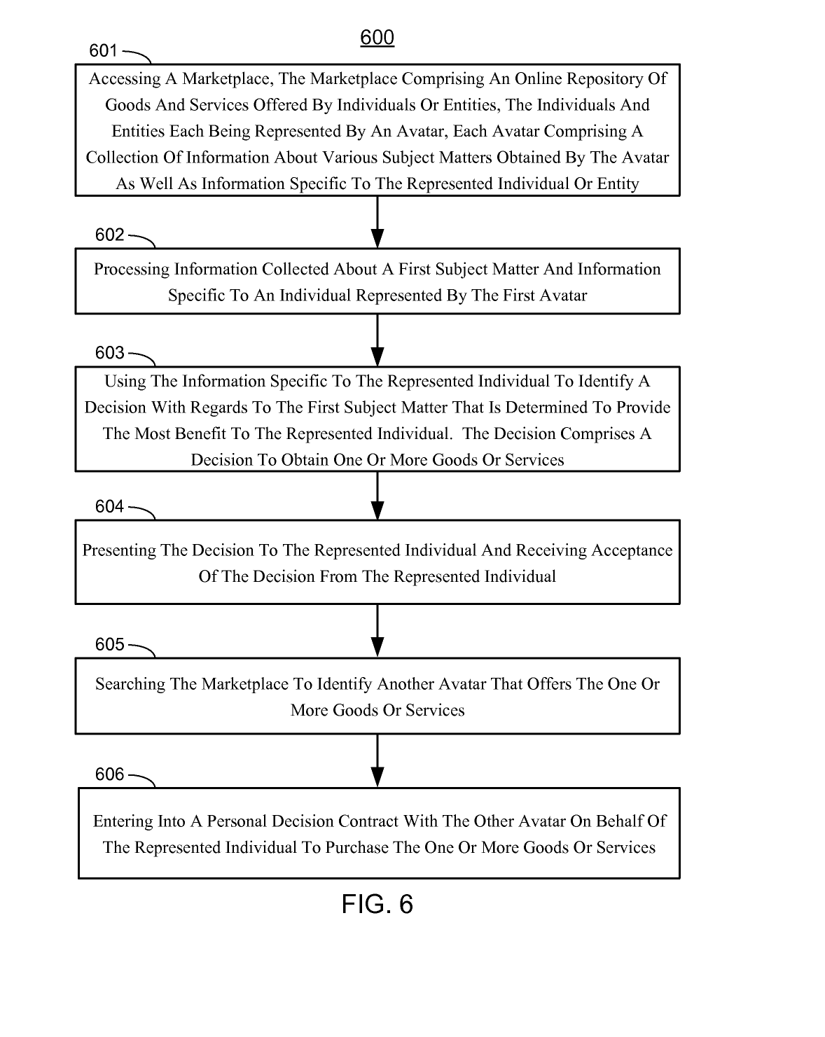

FIG. 6 illustrates a flowchart of an exemplary method 600 for providing a marketplace for allowing avatars to enter into personal decision contracts. Method 600 will be described with reference to the figures.

Method 600 includes an act 601 of a first avatar accessing a marketplace. The marketplace comprises an online repository of goods and services offered by individuals or entities. The individuals and entities are each represented by an avatar. Each avatar comprises a collection of information about various subject matters obtained by the avatar as well as information specific to the represented individual or entity. For example, avatar 202 can access marketplace 500 that acts as an interface for identifying and interacting with other avatars.

Method 600 includes an act 602 of a first avatar processing information collected about a first subject matter and information specific to an individual represented by the first avatar. For example, avatar 202 can process information specific to user 201 with regards to a medically related subject.

Method 600 includes an act 603 of the first avatar using the information specific to the represented individual to identify a decision with regards to the first subject matter that is determined to provide the most benefit to the represented individual. The decision comprises a decision to obtain one or more goods or services. For example, avatar 202 can identify that a particular medical procedure is recommended for user 201.

Method 600 includes an act 604 of the first avatar presenting the decision to the represented individual and receiving acceptance of the decision from the represented individual. For example, avatar 202 can present decision 501 to user 201.

Method 600 includes an act 605 of the first avatar searching the marketplace to identify another avatar that offers the one or more goods or services. For example, avatar 202 can search marketplace 500 to identify other avatars that provide the particular medical procedure.

Method 600 includes an act 606 of the first avatar entering into a personal decision contract with the other avatar on behalf of the represented individual to purchase the one or more goods or services. For example, avatar 202 can select a specific avatar in marketplace 500 and enter into a personal decision contract for the entity or person represented by the selected avatar to provide the particular medical procedure to user 201.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a first avatar representing an individual in a marketplace, for accessing a marketplace of avatars to enter into a personal decision contract on behalf of the represented individual, the method comprising:
accessing a marketplace by a first avatar, the marketplace comprising an online repository of goods and services offered by individuals or entities, the individuals and entities each being represented by an avatar, each avatar comprising a collection of information about various subject matters obtained by the avatar as well as information specific to the represented individual or entity;
processing, by the first avatar, information collected about a first subject matter and information specific to the individual represented by the first avatar;
using the information specific to the represented individual to identify a decision with regards to the first subject matter that is determined to provide the most benefit to the represented individual, the decision comprising a decision to obtain one or more goods or services;
presenting the decision to the represented individual and receiving acceptance of the decision from the represented individual;
searching the marketplace to identify another avatar that offers the one or more goods or services; and
entering into a personal decision contract with the other avatar on behalf of the represented individual to purchase the one or more goods or services.

2. The method of claim 1, wherein the information collected about the first subject matter comprises medical information.

3. The method of claim 2, wherein the information specific to the individual comprises medical information about the individual.

4. The method of claim 3, wherein the medical information about the individual comprises the genetics, medical history, or family medical history of the individual.

5. The method of claim 3, wherein the identified decision comprises a decision to receive a medical procedure.

6. The method of claim 5, wherein the medical procedure is a preventative procedure for identifying a disease.

7. The method of claim 6, wherein the decision is identified based on the individual's genetics, medical history, or family medical history when compared to the collected medical information.

8. The method of claim 1, wherein receiving acceptance of the decision from the represented individual comprises receiving a commitment to honor the personal decision contract entered into by the first avatar.

9. The method of claim 1, wherein the personal decision contract comprises an agreement that the represented individual will receive the one or more goods or services for a specified duration of time.

10. The method of claim 1, wherein the personal decision contract identifies criteria for selected the one or more goods or services to be purchased at a later time.

11. The method of claim 10, wherein the later time comprises multiple later times.

12. The method of claim 1, wherein the other avatar is identified based on a score associated with the other avatar.

13. The method of claim 12, wherein the score comprises an indication of how the individual or entity represented by the other avatar has complied with personal decision contracts entered into with other avatars.

14. The method of claim 1, wherein the information collected about the first subject matter comprises meal preparation information.

15. The method of claim 14, wherein the personal decision contract comprises an agreement to purchase one or more ingredients from the individual or entity represented by the other avatar.

16. The method of claim 14, wherein the personal decision contract comprises an agreement to prepare a meal that is recommended by the individual or entity represented by the other avatar.

17. The method of claim 1, further comprising:
tracking the represented individual's compliance with the personal decision contract; and
modifying a score associated with the first avatar based on the tracked compliance.

18. The method of claim 17, wherein the score indicates that the represented individual has complied with the personal decision contract.

19. The method of claim 1, wherein the other avatar is selected from among a plurality of avatars that provide the one or more goods or services, the method further comprising selecting the other avatar based on the information specific to the represented individual.

20. The method of claim 19, wherein selecting the other avatar based on the information specific to the represented individual comprises using preferences of the individual to select the other avatar, the preferences being derived from the individual's previous acceptance of decisions presented to the individual by the first avatar.
